SEQUENCE LISTING (24 sequences)

SEQ ID NO: 1 - DNA, 23 bp, human
tgcagggcgctcacgcttgctgc

SEQ ID NO: 2 - DNA, 23 bp, human
tgcagggcgctcacgcttgctgt

SEQ ID NO: 3 - DNA, 25 bp, human
agaatgagcgggaccggatcagcac

SEQ ID NO: 4 - DNA, 25 bp, human
agaatgagcgggaccggatcagcat

SEQ ID NO: 5 - DNA, 27 bp, human
agttcctaaccccaggtctcctgacac

SEQ ID NO: 6 - DNA, 27 bp, human
agttcctaaccccaggtctcctgacat

SEQ ID NO: 7 - DNA, 27 bp, human
cagggtgtaacttacccagagctgcac

SEQ ID NO: 8 - DNA, 27 bp, human
cagggtgtaacttacccagagctgcat

SEQ ID NO: 9 - DNA, 22 bp, human
agactgggccctgcacctccca

SEQ ID NO: 10 - DNA, 22 bp, human
agactgggccctgcacctcccg

SEQ ID NO: 11 - DNA, 21 bp, human
gcgggcacggtacctgggctc

SEQ ID NO: 12 - DNA, 21 bp, human
gcgggcacggtacctgggctt

SEQ ID NO: 13 - DNA, 31 bp, human
gctccttatgtgcagacaacattgaaggaaa

SEQ ID NO: 14 - DNA, 31 bp, human
gctccttatgtgcagacaacattgaaggaag

SEQ ID NO: 15 - DNA, 27 bp, human
cagacaagaaggaggacgacctcgaaa

SEQ ID NO: 16 - DNA, 27 bp, human
cagacaagaaggaggacgacctcgaag

SEQ ID NO: 17 - DNA, 26 bp, human
agctataggcgtccatggccagcttc

SEQ ID NO: 18 - DNA, 26 bp, human
agctataggcgtccatggccagcttt

SEQ ID NO: 19 - DNA, 36 bp, human
actgaacaattagagagctaagcactttttagatac

SEQ ID NO: 20 - DNA, 36 bp, human
actgaacaattagagagctaagcactttttagatat

SEQ ID NO: 21 - DNA, 24 bp, human
acccgtcctgtgggggtaactgac

SEQ ID NO: 22 - DNA, 24 bp, human
acccgtcctgtgggggtaactgat

SEQ ID NO: 23 - DNA, 15 bp, unknown
  synthesized
atgcctagcttactg

SEQ ID NO: 24 - DNA, 25 bp, unknown
  synthesized
gcatcctaatacgactcactatagg

(19) United States
(12) Patent Application Publication
(10) Pub. No.: US 2009/0312193 A1
(43) Pub. Date: Dec. 17, 2009

(54) MICROARRAY HYBRIDIZATION ASSAY METHODS

(75) Inventor: Byung-Chul KIM, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 12/333,082

(22) Filed: Dec. 11, 2008

(30) Foreign Application Priority Data
Jan. 23, 2008 (KR) 2008-0007240

(51) Int. Cl. C40B 30/04

(52) U.S. Cl. 506/9

(57) ABSTRACT

An assay method suitable for use in microarray hybridization of a target sample can include providing a microarray having probes, hybridizing the probes to a target sample and random primers each having an arbitrary sequence, ligating a free terminal of each of the probes to one end of each of the random primers in the probe side, removing the target sample hybridized to each of the probes, and measuring the intensity of the remaining random primers.

### CROSS-REFERENCE TO RELATED APPLICATIONS

This application claims priority to Korean Patent Application No. 10-2008-0007240, filed Jan. 23, 2008, the disclosure of which is incorporated herein by reference in its entirety.

### BACKGROUND

The technical field of the disclosed technology relates to assay methods suitable for use in microarray hybridization.

With the recent advent of the Human Genome Project, genome nucleotide sequences of a variety of organisms have been identified and attention has been focused on microarrays. In a microarray, multiple probes are generally arranged on a substrate. It is usually possible to determine the presence [or absence] of predetermined base sequences in a target sample by detecting whether the target sample has been hybridized to the probes on the microarray or not.

In general, in order to assay probe-target hybridization, a fluorescent material is connected to a terminal of a target sample and the fluoresce intensity of a hybridized target sample is observed. However, non-specific binding of the target sample may decrease assay efficiency. Accordingly, research has been conducted to prevent the assay efficiency from decreasing due to the non-specific binding of the target sample, including a method of forming detection sequences at terminals of the target sample, binding primers including complementary sequences to the detection sequences, and annealing the primers and the probes.

However, since a target sample is relatively longer than a probe, the target sample in the form of a single strand usually creates a stable, steric structure, which may block primers at terminals of the target sample from extending toward positions at which probe-primer hybridization occurs, thereby reducing the assay efficiency based on hybridization.

Accordingly, the need remains for assay methods and hybridization techniques and structures that overcome these limitations in the art.

### SUMMARY

The disclosed technology can provide an assay method suitable for use in microarray hybridization of a target sample and probes and, more particularly, to an assay method having improved assay efficiency.

Certain embodiments of the disclosed technology can provide an assay method that includes providing a microarray having multiple probes, hybridizing the probes to a target sample and random primers each having an arbitrary sequence, ligating a free terminal of each of the probes to one end of each of the random primers in the probe side, removing the target sample hybridized to each of the probes, and measuring the intensity of the remaining random primers.

Certain embodiments of the disclosed technology can provide an assay method suitable for use in microarray hybridization that includes providing a microarray having multiple probes hybridized with a target sample and random primers each having an arbitrary sequence, treating the microarray using a ligation solution containing a ligase, washing the microarray, and measuring hybridization intensity of the microarray.

### BRIEF DESCRIPTION OF THE DRAWINGS

Embodiments of the disclosed technology will become more apparent by describing in detail preferred embodiments thereof with reference to the attached drawings.

FIGS. 1 and 2 are sectional views of intermediate structures illustrating assay methods of microarray hybridization according to certain embodiments of the disclosed technology.

FIGS. 3 through 7 are sectional views of intermediate structures illustrating an assay method used in microarray hybridization according to a first embodiment of the disclosed technology.

FIGS. 8 and 9 are sectional views of intermediate structures illustrating an assay method used in microarray hybridization according to a second embodiment of the disclosed technology.

FIG. 10 is a sectional view of an intermediate structure illustrating an assay method used in microarray hybridization according to a third embodiment of the disclosed technology.

### DETAILED DESCRIPTION OF EXAMPLE EMBODIMENTS

The disclosed technology may be understood more readily by reference to the following detailed description of various embodiments and the accompanying drawings. The disclosed technology may, however, be embodied in many different forms and should not be construed as being limited to the embodiments set forth herein. Rather, these embodiments are provided so that this disclosure will be thorough and complete and will fully convey various concepts of the disclosed technology to those skilled in the art, and the present invention will only be defined by the appended claims.

Accordingly, in order to avoid obscuring the invention, in some specific embodiments, well known processing steps, structures, techniques, materials or methods have not been described in detail.

It is noted that the use of any and all examples, or exemplary terms provided herein is intended merely to better illuminate the disclosed technology and is not a limitation on the scope of the invention unless otherwise specified. The use of the terms “a,” “an,” and “the” and similar referents in the context of describing the invention (especially in the context of the following claims) are to be construed to cover both the singular and the plural, unless otherwise indicated herein or clearly contradicted by context. As used herein, the singular forms “a,” an, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “comprising,” “having,” “including,” and “containing” are to be construed as open-ended terms (i.e., meaning “including, but not limited to,”) unless otherwise noted. As used herein the term “and/or” includes any and all combinations of one or more of the associated listed items.

The disclosed technology will be described with reference to perspective views, cross-sectional views, and/or plan views, in which various embodiments of the disclosed technology are shown. Thus, the profile of an exemplary view may be modified according to manufacturing techniques and/or allowances. That is, the described embodiments of the disclosed technology are not intended to limit the scope of the present invention but cover all changes and modifications that can be caused due to a change in manufacturing process. In the drawings, various components may be exaggerated or reduced for clarity. Like reference numerals refer to like elements throughout the specification.

Assay methods used in microarray hybridization according to certain embodiments of the disclosed technology can be used in gene expression profiling, genotyping through detection of mutation or polymorphism (such as Single-Nucleotide Polymorphism (SNP), protein, or peptide assays), potential drug screening, and development and preparation of novel drugs, etc. (e.g., by analyzing biomolecules contained in biolomolecules). In addition, microarrays typically employ appropriate probes according to the kind of biological samples to be analyzed. Examples of suitable probes can include a DNA probe, a protein probe such as an antibody/antigen or a bacteriorhodopsin, a bacterial probe, a neuron probe, etc. According to the kind of probe used, the microarray can also be referred to as a DNA chip, a protein chip, a cellular chip, a neuron chip, etc.

Microarrays according to certain embodiments of the disclosed technology can include oligomer probes. The number of monomers contained in an oligomer probe is typically at an oligomer level. As used herein, the term “oligomer” generally refers to a low-molecular weight polymer molecule consisting of two or more covalently bound monomers. Oligomers typically have a molecular weight of about 1,000 or less. The oligomer can include about 2-500 monomers, preferably 10-80 monomers, but the disclosed technology is not limited thereto.

The monomers can include nucleosides, nucleotides, amino acids, peptides, etc., depending on the type of probes. As used herein, the terms “nucleosides” and “nucleotides” can include not only known purine and pyrimidine bases, but also methylated purines or pyrimidines, acylated purines or pyrimidines, etc.

Furthermore, “nucleosides” and “nucleotides” can include not only known (deoxy)ribose, but also a modified sugar that contains a substitution of a halogen atom or an aliphatic group for at least one hydroxyl group or is functionalized with ether, amine, or the like.

As used herein, the term “amino acids” is intended to refer to not only naturally occurring, L-, D-, and nonchiral amino acids, but also to modified amino acids, amino acid analogs, etc.

As used herein, the term “peptides” generally refers to compounds produced by an amide bond between the carboxyl group of one amino acid and the amino group of another amino acid.

Unless otherwise specified in the following exemplary embodiments, the term “probe” refers to a DNA probe, which is an oligomer probe consisting of about 20-30 covalently bound monomers. However, the disclosed technology is not limited to the probes listed above, and a variety of probes may used.

Embodiments of the disclosed technology will now be described with reference to the accompanying drawings.

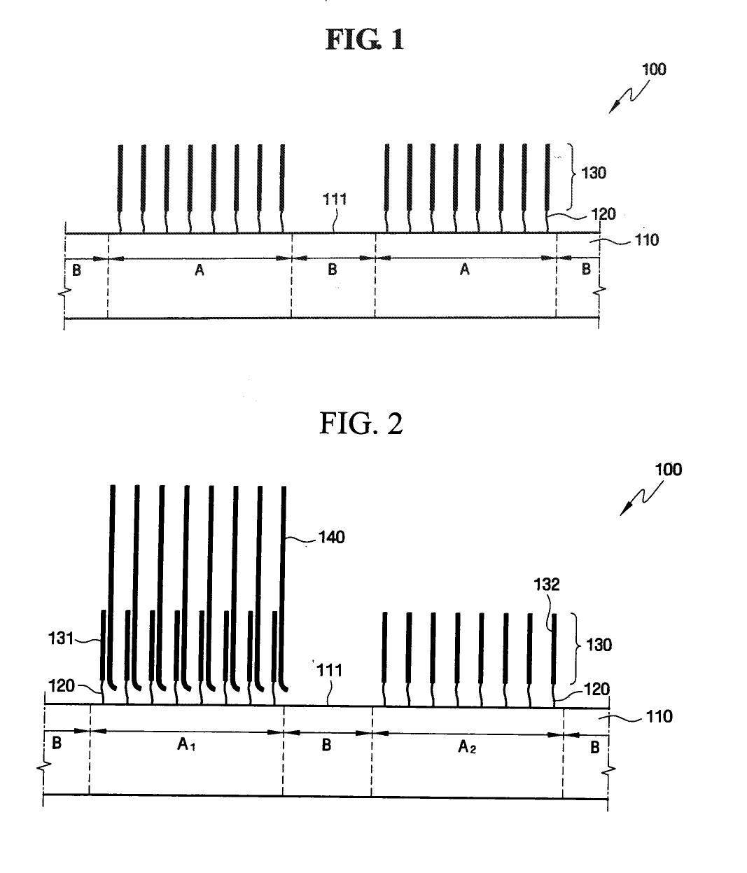

Assay methods of microarray hybridization according to certain embodiments of the disclosed technology will be described with reference to FIGS. 1 and 2, which are sectional views of intermediate structures illustrating assay methods suitable for use in microarray hybridization.

In FIG. 1, a microarray 100 having multiple probes 130 is provided. The microarray 100 can be formed by immobilizing the probes 130 on a substrate 110. The substrate 110 can include probe cell regions A and non-probe cell regions B. The distinction between each of the probe cell regions A and each of the non-probe cell regions B can be based on the presence [or absence] of probes 130 to be immobilizd on the substrate 110.

The probe cell regions A of the substrate 110 are generally substrate regions on which probes are to be immobilized, whereas the non-probe cell regions B are generally substrate regions on which probes are not to be immobilized.

Probes of the same sequence can be immobilized on a top surface 111 of each probe cell region A of the substrate 110. However, probes immobilized on the top surface 111 between different probe cell regions may have different sequences.

The different probe cell regions A can be isolated by the non-probe cell regions B. Therefore, respective probe cell regions A can be surrounded and independently isolated by the non-probe cell regions B. For example, the probe cell regions A can be arranged in a matrix format.

However, a matrix format does not require arrangement at regular pitches. In addition, unlike the independent probe cell regions A, the non-probe cell regions B can be connected to each other. For example, the non-probe cell regions B can be arranged in a lattice format.

In addition, the substrate 110 can be a transparent substrate or an opaque substrate. Examples of an opaque substrate can include a flexible substrate such as a nylon membrane, a nitrocellulose membrane, a plastic film, etc., or a rigid substrate such as a semiconductor wafer. In particular, a semiconductor wafer can be used because it is possible to employ various thin film formation processes and photolithography processes that have been established and stably applied in the fabrication of semiconductor devices. Examples of a transparent wafer can include a transparent glass (e.g., soda-lime glass) wafer.

The substrate 110 can include a top surface 111, and a linker 120 can be formed on the top surface 111. A first end of the linker 120 can be coupled to the top surface 111 and a second end thereof can be coupled to each of the probes 130. The linker 120 can be formed by dipping, for example, but the disclosed technology is not limited thereto.

When the substrate 110 is made of glass, for example, the linker 120 can include silicone groups at the first end and a functional group at the second end, wherein the silicone groups are capable of producing siloxane (Si—O) bonds with Si(OH) groups, and the functional group is capable of being coupled to with probes (including probe monomers). In detail, examples of the linker 120 can include N-(3-(triethoxysilyl)-propyl)-4-hydroxybutyramide, N,N-bis(hydroxyethyl) aminopropyl-triethoxysilane, acetoxypropyl-triethoxysilane, 3-glycidoxy propyltrimethoxysilane, silicone compounds disclosed in International Patent Publication No. WO 00/21967, and the like, the disclosures of which are hereby incorporated by reference as fully set forth herein.

The linker 120 can include a spacer providing a spatial margin for a free interaction with a target sample. If the linker 120 has a sufficient length to ensure a free interaction, the spacer need not be provided, as in the illustrated example.

In the example, the probes 130 are formed on the substrate 110. Immobilizing of the probes 130 on the top surface 111 of the substrate 110 can be performed through mediation of the linker 120. However, the probes 130 can also be formed directly on the top surface 111 of the substrate 110 without the mediation of the linker 120.

In the example, each of the probes 130 has a 3′-terminal and a 5′-terminal. One end of each of the probes 130 (that is, either the 3′-terminal or the 5′-terminal) is immobilized on the top surface 111 directly or through mediation of the linkers 120. The other end of each of the probes 130 is not immobilized on the top surface 111. That is, the other end of each of the probes 130 may be referred to as a free terminal. For example, if the 3′-terminal is immobilized on the substrate 110, then the 5′-terminal is a free terminal whereas, if the 5′-terminal is immobilized on the substrate 110, the 3′-terminal is a free terminal. The direction of extension based on the use of polymerase can vary according to which of the 3′-terminal and the 5′-terminal 3′ is immobilized on the top surface 111. This is described in more detail below.

An example of hybridization of a target sample 140 with the probes 130 will now be described with reference to FIG. 2.

In detail, the target sample 140 can be treated in the microarray 100 having the probes 130 to allow hybridization of the target sample 140 with a probe 131 having a complementary base sequence. In the example, the target sample 140 hybridizes with only the probe 131 having a complementary sequence in the target sample 140, while not hybridizing with a probe 132 that does not have a complementary sequence. Accordingly, a difference in hybridization intensity can be created at different probe cell regions A (e.g., A1 versus A2) on which the probes 131 and 132 having different complementary sequences are immobilized. In addition, since the microarray 100 includes multiple probe cell regions, and the target sample 140 may contain complementary base sequences in the probes 130, hybridization of the target sample 140 with the probes 130 on two or more probe cell regions A having different sequences can occur.

The target sample 140 can include a variety of materials according to use of the probes 130 that are formed on the microarray 100 or use of the microarray 100 itself. Examples of the target sample 140 include, but not limited to, DNA, RNA, an antibody, an antigen, a protein, and so on.

The length of the target sample 140 can be virtually any length that can be annealed to random primers, as described below. For example, the target sample 140 may have the remaining portions of at least 9-mers (preferably 15-mers, and most preferably 80- to 100-mers) in length, the remaining portions not hybridized to the probes 130.

The hybridization conditions of the probes 130 and the target sample 140, including temperature, processing time, etc., can be controlled in various manners according to properties of the probes 130 and the target sample 140. With respect to temperature parameters, for example, a single strand oligonucleotide may be highly probable to be coupled with another single strand oligonucleotide at a relatively low temperature.

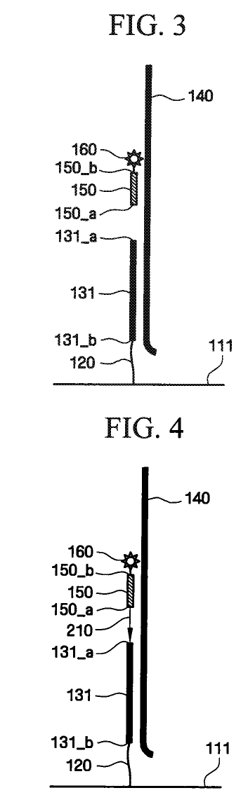

FIGS. 3 through 7 are sectional views of intermediate structures illustrating an assay method suitable for use in microarray hybridization according to a first embodiment of the disclosed technology.

In an assay method used in microarray hybridization according to a first embodiment of the disclosed technology, processing steps will be described with regard to a probe hybridized to a target sample based on the assay method.

In FIG. 3, annealing of a random primer 150 with the target sample 140 is performed.

In detail, the probe 131 hybridized to the target sample 140 can be treated on the top surface 111 using an annealing solution containing the random primer 150, thereby resulting in the annealing of the random primer 150 with the target sample 140. In order to promote annealing intensity of the random primer 150 with the target sample 140, the annealing process can have a duration of about one hour under an annealing condition of about 45° C., for example.

Although not shown, a washing process for cleaning the target sample that is not hybridized to the probe 131 can be performed prior to treatment with the annealing solution. In the washing process, a PBST buffer solution, a 2-fold PBS (phosphate buffered saline) solution, a 0.1% Tween-20 solution, or another suitable solution can be used.

The random primer 150 can be a short segment of arbitrary sequence such as single strand DNA (ssDNA). In the example, the random primer 150 includes nucleotides, which can form various combinations of base sequencing. For example, when the random primer 150 has 8 nucleotides (i.e., 8-mer nucleotides), primers of 48 (i.e., 65,536) sequences can be formed.

Since the random primer 150 in the example has a variety of sequences (i.e., 65,536 sequences), the random primer 150 is annealed to a random site of the target sample 140. In more detail, the random primer 150 is annealed to the target sample 140 at a position where it approaches the probe 131. As the random primer 150 is annealed to a closer site of a free terminal 131_{—}a of the probe 131, the target sample 140 has a smaller spatial margin for a stable steric structure. Accordingly, the annealing probability of the random primer 150 and the probe 131 is increased, and the presence of the probe 131 hybridized to the target sample 140 can be detected with increased accuracy. In other words, the target sample 140 is hybridized to the probe 131 but it is not annealed to the primer. This reduces the possibility of the target sample 140 being left out of the hybridization assay, thereby detecting the presence of an arbitrary sequence contained in the target sample 140 more accurately. Therefore, the assay efficiency of the microarray hybridization can be increased.

In consideration of the relation between the probe 131 and the target sample 140, as well as the microarray hybridization speed and accuracy, the random primer 150 can be from 4-10 nucleotides in length in assay methods used in microarray hybridization according to certain embodiments of the disclosed technology. In more detail, the random primer 150 can be preferably 8 nucleotides. This is described in more detail below with reference to experimental examples.

The random primer 150 can include one end 150_{—}a facing the probe 131 and the other end 150_{—}b opposite to the end 150_{—}a. The end of the random primer 150 can be ligated to a free terminal 131_{—}a of the probe 131 in a subsequent process.

A marker 160 can be connected to the other end 150_{—}b of the random primer 150. The marker 160 can be a material that facilitates microarray hybridization, and various materials can be used according to the method employed. Examples of the method employed can include fluorescent detection, electrochemical detection, detection based on a change in the mass, detection based on a change in the electrical current or charge, or detection based on a difference between optical properties. When fluorescent detection is employed, the marker 160 can be a fluorescent material. Examples of a fluorescent material can include fluorescein, fluorescein, FITC, FAM, TAMRA, Cy3, Cy5, or europium. Connecting of the random primer 150 to the marker 160 can be illustrated by way of example, and other methods can be employed.

In the example, the 3′-terminal of the probe 131 formed on the substrate 110 corresponds to the other end 131_{—}b immobilized on the substrate 110, and the 5′-terminal corresponds to the terminal 131_{—}a, which is a free terminal that is not immobilized to the substrate 110.

In FIG. 4, one end 150_{—}a of the random primer 150 is subjected to an extension reaction 210 toward the free terminal 131_{—}a of the probe 131.

For example, the microarray can be treated with a ligation solution containing a polymerase, thereby forming complementary bases in the target sample 140 from the end 150_{—}a of the random primer 150. The ligation solution can contain base materials for forming the complementary bases in the target sample 140 such as, for example, deoxiNucleotide TriPhosohate mixtures (dNTPs), including dATP, dCTP, dGTP, and dTTP.

Furthermore, the materials contained in the ligation solution (e.g., dNTPs) can be used in the form in which they are contained in the ligation solution (see, e.g., FIG. 3). In this case, the annealing and extension reactions can be concurrently performed at various probe-target sample hybridized structures.

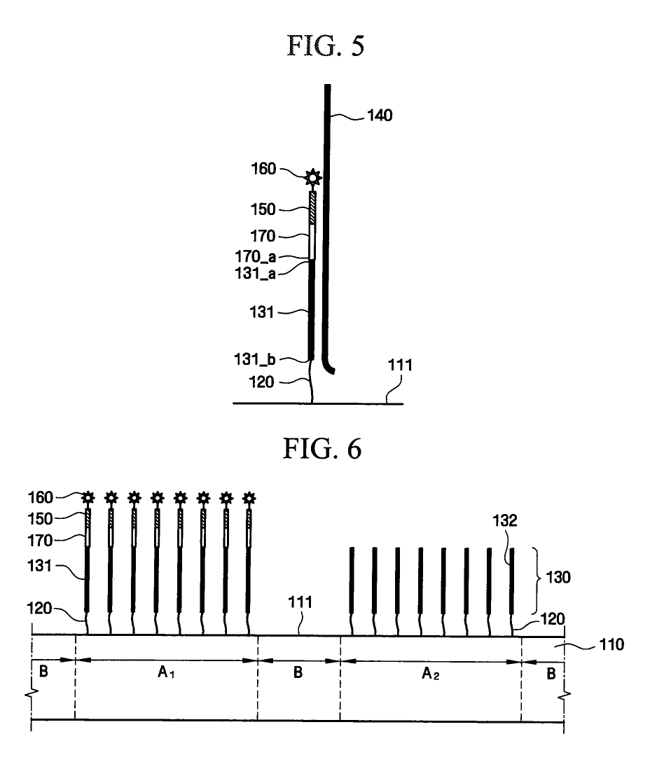

In FIG. 5, one end 170_{—}a of the random primer extended region 170 is ligated to the free terminal 131_{—}a of the probe 131.

As described above, the bases extending from the random primer 150 in the presence of the polymerase form the random primer extended region 170. In addition, the bases directly ligate the end 170_{—}a of the random primer extended region 170 to the free terminal 131_{—}a of the probe 131. In the example, the term “directly ligating” refers to two ends being chemically bonded by a phosphodiester bond, for example, without any formation of additional bases.

The ligating of the end 170_{—}a of the random primer extended region 170 to the free terminal 131_{—}a of the probe 131 can be performed using a ligase. The ligase can be an enzyme that binds two molecules using energy. Specifically, the ligase can be a DNA ligase that produces a phosphodiester bond. In the example, the ligase may be one of a variety of different types according to the type of the probe 131 or the target sample 140 and the assay purpose. Thus, the example of the ligase is not limited to that listed above.

In order to ligate the end 170_{—}a of the random primer extended region 170 to the free terminal 131_{—}a of the probe 131, a ligation reaction can be induced under appropriate conditions including, for example, a temperature of about 37° C. and a treatment duration of about one hour.

In FIG. 6, the target sample 140 hybridized to the probe 131 is removed and the intensity of the remaining random primer 150 is measured. Removal of the target sample 140 hybridized to the probe 131 can include the removal of a hydrogen bond between the probe 131 and the target sample 140.

Since a difference in the hybridization intensity may be created at different probe cell regions A (e.g., A1 and A2) on which the probes 131 and 132 having different complementary sequences are immobilized (as discussed above), target samples may be hybridized only with the probes 130 on an arbitrary probe cell region (see, e.g., A₁ in FIG. 2). Accordingly, after the above-described processes (e.g., annealing, extension, and ligation reactions), only the probe 131 having sequences complementary to those of the target sample 140 generally can be ligated to the random primer extended region 170 and the random primer 150.

On the other hand, the probe 132 that is not hybridized to the target sample (e.g., the probe without sequences complementary to those of the target sample 140) is generally in the same state as immobilized on the top surface 111 (see, e.g., FIG. 1).

Measuring the intensity of the probe 131 connected to the random primer 150 can include measuring the intensity of the marker 160 connected to the other end 150_{—}b of the random primer 150. In addition, various methods can be employed to measure the intensity of the probe 131 connected to the random primer 150. For example, when fluorescent detection is employed, the marker 160 can be a fluorescent material and, based on the fluorescent intensity of the fluorescent material connected to the probe 131, it would be possible to identify whether the target sample contains an arbitrary sequence or not.

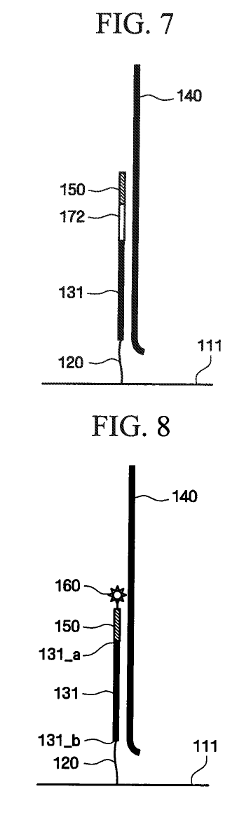

Alternatively, as shown in FIG. 7, a fluorescent random primer extended region 172 (along with the extension of the random primer 150) can be formed by including a base material containing a fluorescent material in the ligation solution used in the extension of the random primer 150, rather than by connecting a marker (see, e.g., 160 of FIG. 5) to the random primer 150. Thus, it is also possible to measure hybridization intensity of the target sample 140 and the probe 131 by measuring the fluorescence intensity of the fluorescent random primer extended region 172. In addition, the hybridization intensity of the target sample 140 and the probe 131 can be measured in various assay methods.

In an assay method used in microarray hybridization according to a first embodiment of the disclosed technology, a random primer connected to a marker can be annealed to a target sample at a position where it approaches a probe, thereby reducing the length of a random primer extended region. In other words, the length between the position at which the random primer is annealed to the target sample and a free terminal of the probe can be shortened, thereby impeding formation of a stable steric structure of the target sample. Accordingly, an extension reaction ranging from the random primer to the probe can be facilitated, and a missing probability of the ligation of the random primer hybridized and the target sample may be reduced, thereby further increasing assay efficiency of microarray hybridization.

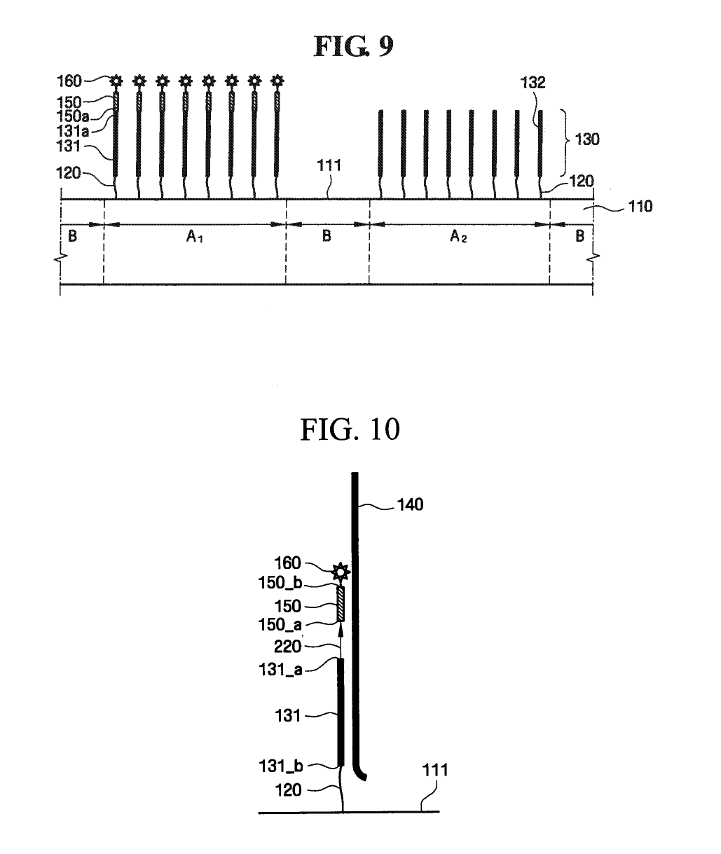

FIGS. 8 and 9 are sectional views of intermediate structures illustrating an assay method suitable for use in microarray hybridization according to a second embodiment of the disclosed technology.

An assay method used in microarray hybridization according to a second embodiment of the disclosed technology is substantially similar to that according to the first embodiment except for annealing of a random primer.

Since certain processing steps in the assay method of the second embodiment are substantially similar to those of the first embodiment, the following description of the second embodiment will focus on the features that differ from the first embodiment. The same reference numerals of the second embodiment will denote the same elements as those of the first embodiment and, thus, detailed descriptions thereof will be omitted or briefly made.

In FIG. 8, the random primer 150 is annealed to the target sample 140. Specifically, the random primer 150 is annealed to a closer site to the free terminal 131_{—}a of the probe 131.

In the example, the term “closer site” generally refers to a state in which one end 150_{—}a of the random primer 150 and the free terminal 131_{—}a of the probe 131 are not chemically bonded to each other even though there is no space for an additional base to be formed between the one end 150_{—}a of the random primer 150 and the free terminal 131_{—}a of the probe 131. For example, assuming that the sequence of the target sample 140 is (3′) . . . G-T-C-A-T-T-C-G-A-T-C-C-G-T-A . . . (5′), the random primer 150 and the probe 131 are correlated as follows:

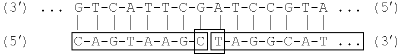

wherein the upper sequence refers to the target sample 140, the left-most box of the lower sequence refers to the random primer 150, the right-most box of the lower sequence refers to the probe 131, the lines between the upper and lower sequences indicate hydrogen bonds of complementary bases, and a hyphen (-) between neighboring bases indicates a chemically bonded state. As indicated by a smaller box located at the center of the lower sequence, ‘C’ and ‘T’ are not chemically bonded to each other even though there is no additional base to be formed between ‘C’ and ‘T’ (i.e., between the one end 150_{—}a of the random primer 150 and the free terminal 131_{—}a of the probe 131).

In FIG. 9, the one end 150_{—}a of the random primer 150 and the free terminal 131_{—}a of the probe 131 are directly ligated to each other and the target sample hybridized to the probe 131 is removed.

In the example, the direct ligation of the one end 150_{—}a of the random primer 150 and the free terminal 131_{—}a of the probe 131 can be performed in a more efficient manner by skipping the extension reaction of the random primer 150 using a polymerase, unlike in the first embodiment. In addition, the direct ligation of the one end 150_{—}a of the random primer 150 and the free terminal 131_{—}a of the probe 131 can be performed using a ligase. To effect the direct ligation of the one end 150_{—}a of the random primer 150 and the free terminal 131_{—}a of the probe 131, a ligation reaction can be induced by reacting the one end 150_{—}a of the random primer 150 and the free terminal 131_{—}a of the probe 131 under appropriate conditions of temperature and time (e.g., at about 37° C. for about 30 minutes).

Then, the processes of removing the target sample hybridized to the probe 131 and measuring the intensity of the marker 160 are substantially similar to those of the assay method used in microarray hybridization according to the first embodiment.

In an assay method used in microarray hybridization according to a second embodiment of the disclosed technology, the random primer 150 can be annealed to the probe 131 at a closer site of the probe 131, thereby skipping the extension reaction of the random primer 150, thereby allowing the probe 131 and random primer 150 to be directly ligated even if the target sample 140 is elongated. Accordingly, the target sample 140 may not have a sufficient spatial margin for forming a stable steric structure of the target sample 140 between ligation reaction sites at which the probe 131 and the random primer 150 are annealed to the target sample 140, so that the ligation of the random primer 150 and the probe hybridized to the target sample 140 is facilitated. Consequently, the sequence of the target sample can be more accurately detected. In other words, the efficiency of the assay method used in microarray hybridization can be further enhanced.

FIG. 10 is a sectional view of an intermediate structure illustrating an assay method used in microarray hybridization according to a third embodiment of the disclosed technology.

Since certain processing steps in the assay method of the third embodiment are substantially similar to those of the first embodiment of the disclosed technology, the following description of the third embodiment will focus on the features that differ from the first embodiment.

In FIG. 10, a free terminal 131_{—}a of a probe 131 is subjected to an extension reaction 220 toward one end 150_{—}a of a random primer 150.

As described above with reference to FIG. 4, a microarray can be treated using, for example, a ligation solution containing a polymerase to induce extension 220 to the probe 131. In an assay method suitable for use in microarray hybridization according to a third embodiment of the disclosed technology, the free terminal 131_{—}a of the probe 131 can be a 3′-terminal, and the extension 220 based on the use of polymerase can be performed toward the one end 150_{—}a of a random primer 150 at the free terminal 131_{—}a.

In an alternative embodiment, a marker 160 may not be connected to the other end 150_{—}b of the random primer 150 by employing a base containing a fluorescent material as a base material, as described above. In another embodiment, where the free terminal 131_{—}a of the probe 131 is a 3′-terminal and the random primer 150 is formed in the vicinity of the free terminal 131_{—}a (as shown in FIG. 8, for example), the random primer 150 and the probe 131 can be directly ligated to each other without an extension reaction using a polymerase. The random primer 150 can include one end 150_{—}a facing the probe 131 and the other end 150_{—}b opposite to the end 150_{—}a. The end of the random primer 150 can be ligated to a free terminal 131_{—}a of the probe 131 in a subsequent process.

The marker 160 can be a material that facilitates microarray hybridization, and various materials can be used according to the method employed.

### Experimental Examples

Subjects for the assay of microarray hybridization were 22 sequences in total, including SNP Nos. 1-11 for 11 SNP positions, were selected from 9 human genes. The human gene has the following base sequences:

TABLE 1
Test Subjects for Microarray Assay

| | | | |
|---|---|---|---|
| | | | Probe sequence |
| SNP # | Gene | SNP ID | (5′ to 3′) |

| | | | |
|---|---|---|---|
| 1 | CAPN10 | rs2975760 | TGCAGGGCGCTCACGCTTGCTG |
| | | | [C/T] |
| 2 | HNF4A | rs1800961 | AGAATGAGCGGGACCGGATCAGCA |
| | | | [C/T] |
| 3 | HNF4A | rs13433202 | AGTTCCTAACCCCAGGTCTCCTGA |
| | | | CA[C/T] |
| 4 | HNF4A | rs1884614 | CAGGGTGTAACTTACCCAGAGCTG |
| | | | CA[C/T] |
| 5 | IRS1 | rs1801278 | AGACTGGGCCCTGCACCTCCC |
| | | | [A/G] |
| 6 | KCNJ11 | rs5219 | GCGGGCACGGTACCTGGGCT |
| | | | [C/T] |
| 7 | LEPR | rs1137100 | GCTCCTTATGTGCAGACAACATTG |
| | | | AAGGAA[A/G] |
| 8 | NEUROD1 | rs1801262 | CAGACAAGAAGGAGGACGACCTCG |
| | | | AA[A/G] |
| 9 | TCF2 | rs34973944 | AGCTATAGGCGTCCATGGCCAGCT |
| | | | T[C/T] |
| 10 | TCF7L2 | rs7903146 | ACTGAACAATTAGAGAGCTAAGCA |
| | | | CTTTTTAGATA[C/T] |
| 11 | UCP2 | rs659366 | ACCCGTCCTGTGGGGGTAACTGA |
| | | | [C/T] |

The microarray was treated using a target sample solution containing a target sample (100 μl (0.1 ng/μl)), and further treated at 45° C. for one hour to allow the target sample to be hybridized to the probe. In Experimental Example 1, a Cy5-labeled oligonucleotide detection primer (final concentration of 2 μM, 5′/Cy5/GCATCCTAATACGACTCACTATAGG) was hybridized to 5′-terminal by a gene expression assay method, as disclosed in U.S. Published Application No. 2006/0240443. In Experimental Examples 2-4, a Cy3-labeled random primer (final concentration of 2 μM) was hybridized to 5′-terminal of each of 4, 6, and 8 nucleotides to induce hybridization. Next, the microarray was repeatedly washed using PBST buffer for one minute twice, using PBS buffer for one minute twice, and ligase buffer for one minute twice, respectively.

The washed microarray was treated using 100 uL of a polymerization-ligation solution at 37° C. for 30 minutes, the polymerization-ligation solution comprising 84 μl of nuclease-free water, 10 μl of 10-fold DNA ligase buffer, 2 μl of 10 mM dNTP, DNA polymerase (AmpliTaq®), 2 μl of Stoffel Fragment, and 2 μl of a DNA ligase (E. coli), thereby causing annealing, extension, and ligation to the random primer and the target sample.

Next, bases of SNPs of the microarrays treated by the methods of Experimental Examples 1-4 were identified and the results thereof are shown in Table 1.

In Experimental Examples 1-4, a customized microarray, which can process 4 samples for each chip (i.e., each probe quartet) was used. The microarray had a set of four spots of A (adenine), C (cytosine), T (thymine), and G (guanine) at 11 SNP positions, wherein each set was repeatedly disposed 23 times at different positions on the microarray. Making a genotype call was performed by statistically processing the mean and standard deviation of fluorescent signals detected from 23 identical probes for comparison of relative intensity of A, C, G, and T spots belonging to a single SNP position.

TABLE 2
Experimental Results

| | Base | | | | |
|---|---|---|---|---|---|
| SNP # | Sequence | Exp. 1 | Exp. 2 | Exp. 3 | Exp. 4 |
| 1 | C/C | No call | No call | No call | No call |
| 2 | C/C | C/C | No call | C/C | C/C |
| 3 | T/T | T/T | No call | T/T | T/T |
| 4 | C/T | No call | No call | No call | C/T |
| 5 | C/C | A/G | No call | No call | A/G |
| 6 | C/T | No call | No call | C/T | C/T |
| 7 | G/G | G/G | No call | No call | G/G |
| 8 | A/A | A/G | No call | G/G | No call |
| 9 | G/G | G/G | No call | G/G | G/G |
| 10 | C/C | C/C | No call | C/C | C/C |
| 11 | T/T | T/T | No call | T/T | T/T |

In Table 2, genotypes listed in base sequence analysis columns are ones known by the standard gene base sequence analysis method. In columns of Experimental Examples 1-4, genotypes resulting from the respective microarray experiments are listed, and “No call” results in genotype detection refer to erroneous genotypes detected.

Referring to Table 2, the accuracy levels of Experimental Examples 1-4 were 6/11 (55%), 0/11 (0%), 6/11 (55%), and 8/11 (73%), respectively. As is evident from Table 2, the use of 6-mer random primers can provide for the same accuracy level as that of the conventional assay method. Furthermore, the use of a random primer of 8 nucleotides in length can further increase accuracy compared to a conventional assay method.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims to indicate the scope of the invention.

1. An assay method suitable for use in microarray hybridization, comprising:
providing a microarray having a plurality of probes;
hybridizing each of the plurality of probes to a target sample and a plurality of random primers each having an arbitrary sequence;
ligating a free terminal of each of the plurality of probes to one end of each of the plurality of random primers;
removing the target sample hybridized to each of the plurality of probes; and
measuring an intensity of remaining random primers.

2. The assay method of claim 1, wherein each of the plurality of random primers is about 4-10 nucleotides in length.

3. The assay method of claim 2, wherein each of the plurality of random primers is about 8 nucleotides in length.

4. The assay method of claim 1, wherein an other end of each of the plurality of random primers is ligated to a marker.

5. The assay method of claim 4, wherein the marker comprises a fluorescent material.

6. The assay method of claim 1, wherein the ligating of the free terminal comprises directly ligating the one end of each of the plurality of random primers to the free terminal of each of the plurality of probes using a ligase.

7. The assay method of claim 1, wherein the free terminal of each of the plurality of probes comprises a 5′-terminal.

8. The assay method of claim 7, wherein the ligating of the free terminal comprises:
forming a random primer extended region complementary to the target sample by extending each of the plurality of random primers from the one end of each of the plurality of random primers; and
using a ligase, ligating the free terminal of each of the hybridized probes to the one end of the random primer extended region.

9. The assay method of claim 1, wherein the free terminal of each of the plurality of probes comprises a 3′-terminal.

10. The assay method of claim 9, wherein the ligating of the free terminal of each of the plurality of hybridized probes to one end of each of the plurality of random primers comprises:
forming a probe extended region complementary to the target sample by extending each of the plurality of probes from the free terminal of each of the plurality of probes; and
using a ligase, ligating the probe extended region to the one end of each of the plurality of random primers.

11. The assay method of claim 1, wherein the target sample has at least about 9-mers in length of the remaining portions that are not hybridized to the probes.

12. An assay method suitable for use in microarray hybridization comprising:
providing a microarray having a plurality of probes hybridized with a target sample and random primers each having an arbitrary sequence;
treating the microarray using a ligation solution containing a ligase;
washing the microarray; and
measuring hybridization intensity of the microarray.

13. The assay method of claim 12, wherein each of the random primers is from about 4-10 nucleotides in length.

14. The assay method of claim 13, wherein each of the random primers is about 8 nucleotides in length.

15. The assay method of claim 12, wherein the one end of the random primer is connected to a fluorescent material, and the treating of the microarray comprises treating by using the ligation solution comprising the random primer connected to the fluorescent material and the ligase.

16. The assay method of claim 15, wherein the ligation solution further comprises a polymerase.

17. The assay method of claim 12, wherein the ligation solution further comprises polymerase and fluorescence-labeled bases.

18. The assay method of claim 12, wherein the target sample has at least 9-mers in length of the remaining portions that are not hybridized to the probes.
